(19) United States
(12) Patent Application Publication
(10) Pub. No.: US 2017/0034710 A1
(43) Pub. Date: Feb. 2, 2017

(54) Method, Apparatus and System

(71) Applicant: Nokia Solutions and Networks Oy, Espoo (FI)

(72) Inventors: Min SHU, Beijing (CN); Linsheng LIAO, Beijing (CN); Hongchang XIAO, Beijing (CN)

(21) Appl. No.: 15/303,303

(22) PCT Filed: Apr. 11, 2014
(86) PCT No.: PCT/CN2014/075143

§ 371 Date: Oct. 11, 2016

(51) Int. Cl. H04W 16/14; H04W 16/10

(52) U.S. Cl. CPC H04W 16/14; H04W 16/10; H04W 88/08

(57) ABSTRACT

There is provided a method including determining for a plurality of baseband units, in dependence on one or more parameters, which radio access technology is supported by a respective base band unit and causing said baseband unit to operate in said respective radio access technology.

The present application relates to a method, apparatus and system and in particular but not exclusively, to baseband resource management.

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communications may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless communication system at least a part of communications between at least two stations occurs over a wireless link. Examples of wireless systems include public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3^{rd} Generation Partnership Project (3GPP). The various development stages of the 3GPP LTE specifications are referred to as releases. The aim of the standardization is to achieve a communication system with, inter alia, reduced latency, higher user data rates, improved system capacity and coverage, and reduced cost for the operator. In the following certain example embodiments are explained with reference to a wireless or mobile communication system serving mobile communication devices.

In a first aspect there is provided a method comprising determining for a plurality of baseband units, in dependence on one or more parameters, which radio access technology is supported by a respective base band unit and causing said baseband unit to operate in said respective radio access technology.

The one or more parameters may comprise the number of cells supported by the respective radio access technology.

The one or more parameters may comprise the number of the plurality of baseband units required to support the respective radio access technology.

The parameters may relate to the base station interface protocol.

The method may comprise obtaining software configured to run the baseband unit according to the determined radio access technology mode.

The one or more parameters may comprise radio access technology prioritisation information.

The method may comprise using the radio access technology prioritisation information to determine which of said plurality of baseband units is first caused to operate in said respective radio technology.

The method may comprise using the radio access technology prioritisation information to determine which radio access technology is supported by a respective base band unit, for at least one baseband unit that is not required to support a particular radio access technology.

The method may comprise receiving the parameters from a network management node.

The base band unit may be capable of supporting a plurality of different radio access technologies or versions of radio access technologies.

The radio access technology may be one of a version of 3G and a version of LTE.

In a second aspect there is provided a method comprising receiving parameters at a network management node for use in determining, for a plurality of baseband units, which radio access technology is supported by a respective base band unit and causing the parameters to be sent to a base station arrangement.

The one or more parameters may comprise at least one of the number of cells supported by the respective radio access technology, the number of the plurality of baseband units required to support the respective radio access technology, and radio access technology prioritisation information.

The parameters may relate to the base station interface protocol.

The base band unit may be capable of supporting a plurality of different radio access technologies or versions of radio access technologies.

The radio access technology may be one of a version of 3G and a version of LTE.

In a third aspect there is provided an apparatus, said apparatus comprising at least one processor and at least one memory including computer code for one or more programs, the at least one memory and the computer code configured, with the at least one processor, to cause the apparatus at least to determine for a plurality of baseband units, in dependence on one or more parameters, which radio access technology is supported by a respective base band unit and cause said respective base band unit to operate in said respective radio access technology.

The one or more parameters may comprise the number of cells supported by the respective radio access technology.

The one or more parameters may comprise the number of the plurality of baseband units required to support the respective radio access technology.

The parameters may relate to the base station interface protocol.

The at least one memory and the computer code may be configured, with the at least one processor to cause the apparatus to obtain software configured to run the baseband unit according to the determined radio access technology mode.

The one or more parameters may comprise radio access technology prioritisation information.

The at least one memory and the computer code may be configured, with the at least one processor to cause the apparatus to use the radio access technology prioritisation information to determine which of said plurality of baseband units is first caused to operate in said respective radio technology.

The at least one memory and the computer code may be configured, with the at least one processor to cause the apparatus to use the radio access technology prioritisation information to determine which radio access technology is supported by a respective base band unit, for at least one baseband unit that is not required to support a particular radio access technology.

The at least one memory and the computer code may be configured, with the at least one processor to cause the apparatus to receive the parameters from a network management node.

The base band unit may be capable of supporting a plurality of different radio access technologies or versions of radio access technologies.

The radio access technology may be one of a version of 3G and a version of LTE.

In a fourth aspect there is provided an apparatus, said apparatus comprising at least one processor and at least one memory including computer code for one or more programs, the at least one memory and the computer code configured, with the at least one processor, to cause the apparatus at least to receive parameters at a network management node for use in determining, for a plurality of baseband units, which radio access technology is supported by a respective base band unit and cause the parameters to be sent to a base station arrangement.

The one or more parameters may comprise at least one of the number of cells supported by the respective radio access technology, the number of the plurality of baseband units required to support the respective radio access technology, and radio access technology prioritisation information.

The parameters may relate to the base station interface protocol.

The base band unit may be capable of supporting a plurality of different radio access technologies or versions of radio access technologies.

The radio access technology may be one of a version of 3G and a version of LTE.

In a fifth aspect there is provided an apparatus comprising means for determining for a plurality of baseband units, in dependence on one or more parameters, which radio access technology is supported by a respective base band unit and means for causing said baseband unit to operate in said respective radio access technology.

The one or more parameters may comprise the number of cells supported by the respective radio access technology.

The one or more parameters may comprise the number of the plurality of baseband units required to support the respective radio access technology.

The parameters may relate to the base station interface protocol.

The apparatus may comprise means for obtaining software configured to run the baseband unit according to the determined radio access technology mode.

The one or more parameters may comprise radio access technology prioritisation information.

The apparatus may comprise means for using the radio access technology prioritisation information to determine which of said plurality of baseband units is first caused to operate in said respective radio technology.

The apparatus may comprise means for using the radio access technology prioritisation information to determine which radio access technology is supported by a respective base band unit, for at least one baseband unit that is not required to support a particular radio access technology.

The apparatus may comprise means for receiving the parameters from a network management node.

The base band unit may be capable of supporting a plurality of different radio access technologies or versions of radio access technologies.

The radio access technology may be one of a version of 3G and a version of LTE.

In a sixth aspect there is provided an apparatus comprising means for receiving parameters at a network management node for use in determining, for a plurality of baseband units, which radio access technology is supported by a respective base band unit and means for causing the parameters to be sent to a base station arrangement.

The one or more parameters may comprise at least one of the number of cells supported by the respective radio access technology, the number of the plurality of baseband units required to support the respective radio access technology, and radio access technology prioritisation information.

The parameters may relate to the base station interface protocol.

The base band unit may be capable of supporting a plurality of different radio access technologies or versions of radio access technologies.

The radio access technology may be one of a version of 3G and a version of LTE.

A computer program comprising program code means adapted to perform the method(s) may also be provided. The computer program may be stored and/or otherwise embodied by means of a carrier medium.

In the above, many different embodiments have been described. It should be appreciated that further embodiments may be provided by the combination of any two or more of the embodiments described above.

Embodiments will now be described, by way of example only, with reference to the accompanying Figures in which:

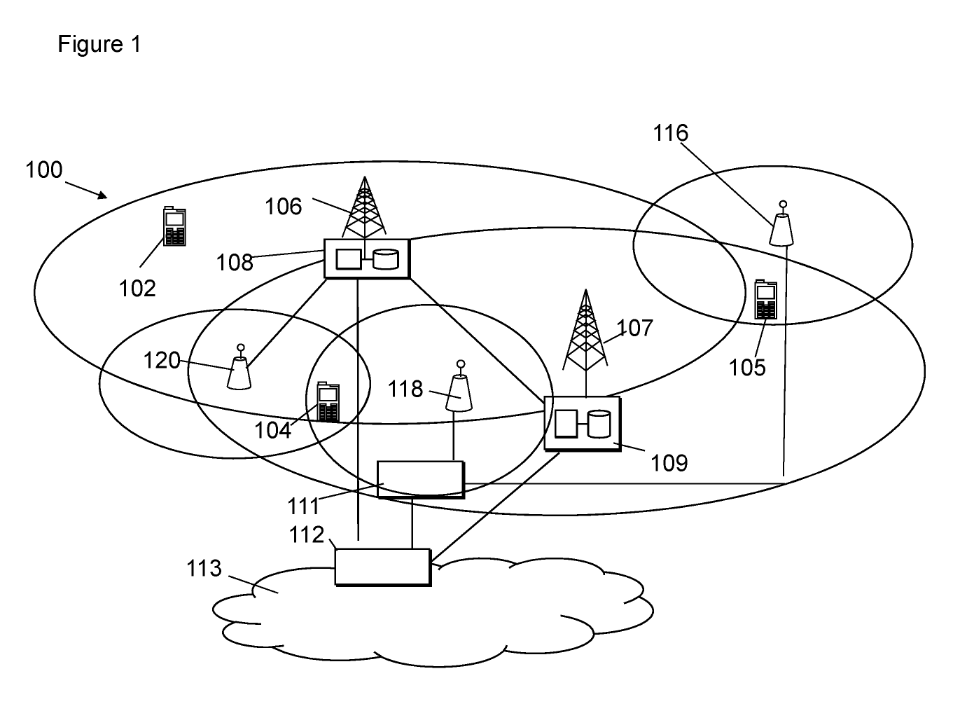

FIG. 1 shows a schematic diagram of an example communication system comprising a base station and a plurality of communication devices;

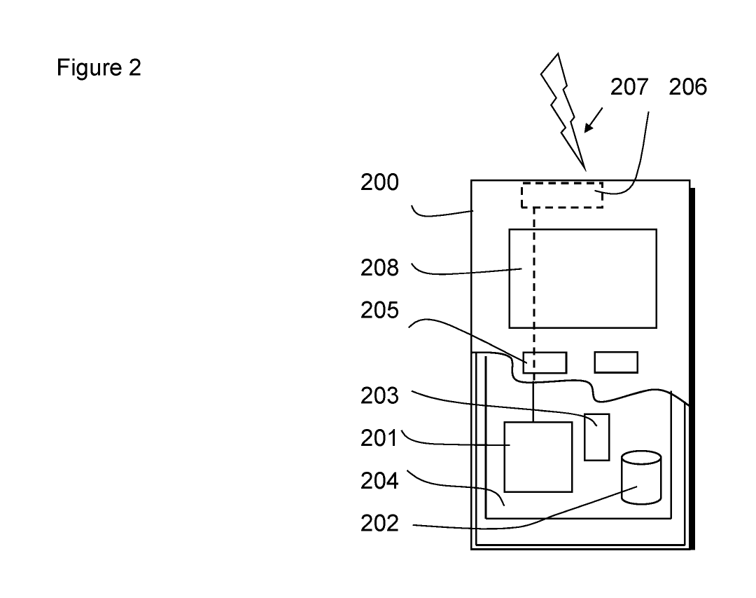

FIG. 2 shows a schematic diagram, of an example mobile communication device;

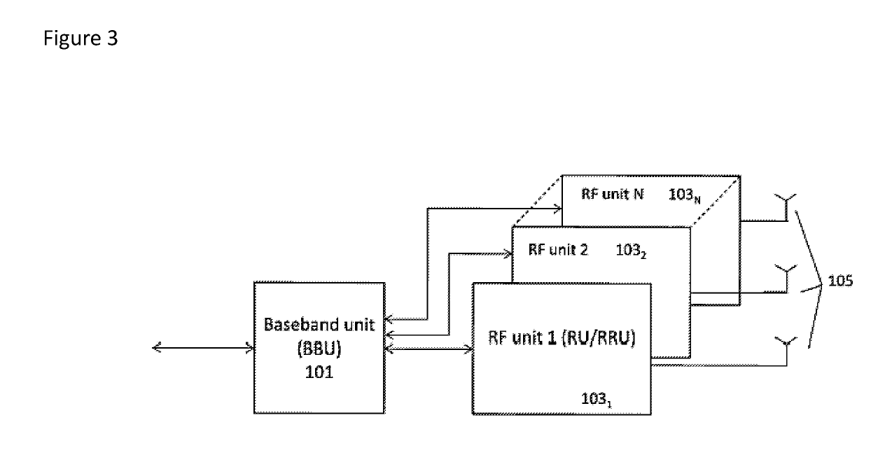

FIG. 3 shows an example of a base station suitable for employing some embodiments;

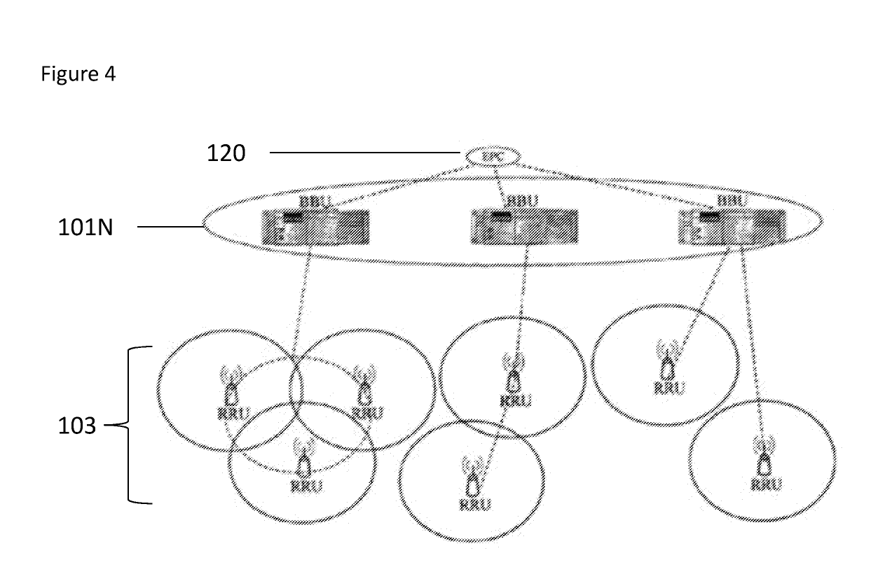

FIG. 4 shows an example of a baseband pool;

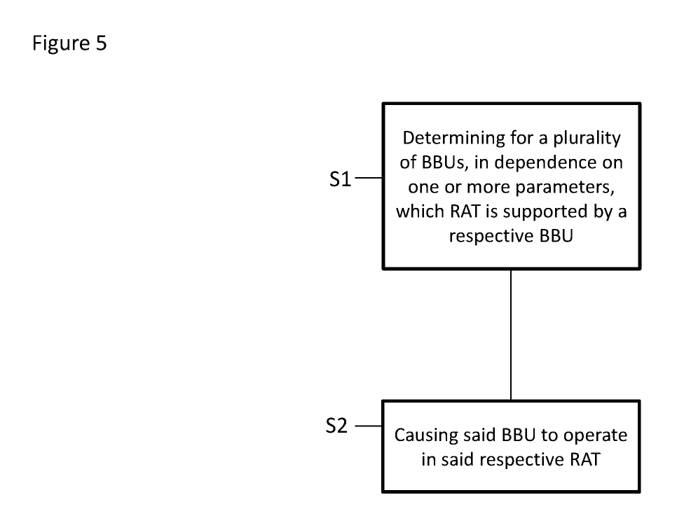

FIG. 5 shows an example flowchart of a method for assigning radio access technology modes according to some embodiments;

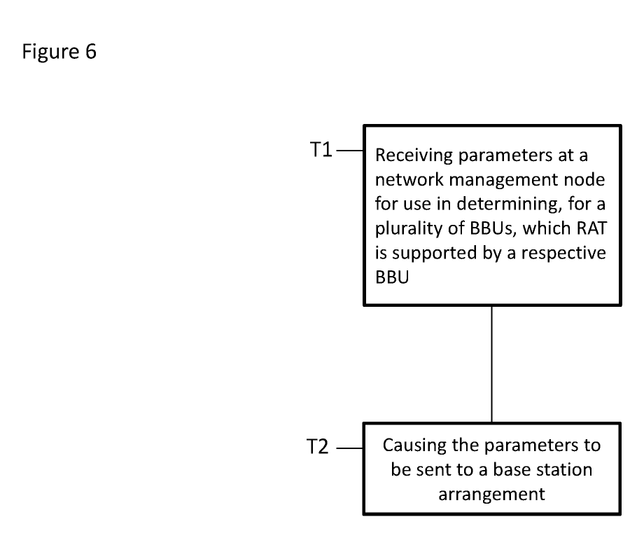

FIG. 6 shows an example flow chart of a method for providing parameters for use in assigning radio technology modes;

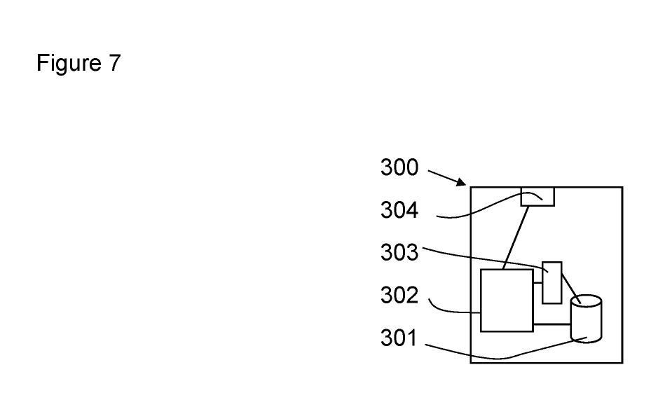

FIG. 7 shows a schematic diagram of an example control apparatus;

Before explaining in detail the examples, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point.

Base stations are typically controlled by at least one appropriate controller apparatus, so as to enable operation thereof and management of mobile communication devices in communication with the base stations. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GVV) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. In the example, stations 116 and 118 are connected via a gateway 111 whilst station 120 connects via the controller apparatus 108. In some embodiments, the smaller stations may not be provided.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples include a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (I FDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (WorldwideInteroperability for Microwave Access).

Base stations, base station nodes, access points or Base Transceiver Stations (BTS) are widely used as part of cellular network based on Radio Access Technologies (RAT), like GSM, (W)CDMA or LTE. Typically a BTS comprises at least one Base Band Unit (BBU) and at least one Radio Unit (RU) or Remote Radio Unit (RRU). Within the BTS a dedicated protocol is used to achieve flexible handling of control and user plane data exchange, for example between the BBU and the (R)RU nodes inside the BTS topology. Common Public Radio Interface (CPRI) is one such protocol. Base stations may be co-located. In some situations, co-located base stations may share some hardware or may each have their own hardware.

The base transceiver station 12 will now be described in further detail with reference to FIG. 3. FIG. 3 discloses a base station 12 according to some embodiments. The base station 12 comprises at least one base band unit (BBU) 101 which can perform system operations such as communicating with a core network. In some embodiments the base transceiver station 12 comprises at least one RF unit (RU) or remote RF unit (RRU) 103. In the example shown in FIG. 3 the base transceiver station 12 comprises N RF units labelled 1031 1032 and 103N. The base band unit BBU 101 communicates with a radio frequency units (RU)/remote radio units (RRU) over a defined interface. The radio frequency unit 103 is configured to convert base band signals into a format suitable for transmission over a wireless network. The radio frequency unit 103 sends signals for wireless transmissions to an antenna system 105. The antenna system 105 comprises a plurality of antennas. In some embodiments the radio frequency unit is separate from the base band unit, however alternatively the radio frequency unit and the base band unit may be comprised in the same network entity. In some other embodiments the antenna system 105 and the radio frequency unit 103 may be comprised in the same network entity. The plurality of antennas may be used together for the purposes of beam forming wireless transmissions.

LRC (Liquid Radio Cloud) is a product platform which can support multi-mode radio access. For example, it can support both LTE and 3G and can be used for modernizing existing 3G networks. LRC may also be able to support other radio access technologies or versions of radio access technologies and provide, for example, LTE-A services.

The LRC may provide the BBUs of the BTS, for both 3G and LTE modes, according to CPRI reference architecture. All of the hardware of LRC is capable of supporting 3G and LTE at the same time. This can allow efficient spectrum sharing.

In the LRC platform, one base station can provide a wider range of coverage over a selected area or region by implementing a baseband resource pool and assigning resources dynamically. In this case, the base station handles the multi-mode radio resources dynamically, and adapts to support multi-mode terminals and change of user or data throughput.

As shown in FIG. 4, the baseband resource is shared by a BBU pool 101N. The hardware of the BBUs can connect to all the radio ports 103 regardless of whether the BBUs process LTE or 3G. The communication system shown in FIG. 4 is an example only and LTE and 3G are examples of RATs. The BBU pool 101N interfaces with the Evolved Packet Core (EPC) 120 which contains the S-GW and the MME.

When operators design a network system, they will assign a RAT mode for each BBU, for example, according to the target service load of the network system. The BBU runs different software depending on the assigned RAT mode of the BBU.

As shown in FIG. 5, a method is provided to select RAT mode of a BBU dynamically according to parameters such as RAT cell number, RAT BBUs, RAT Priority and the available hardware. This may make it possible to support a great variety of mixed bandwidth (BW) configurations, and may improve the resource utilization.

The first step, S1, comprises determining for a plurality of BBUs, in dependence of one or more parameters which RAT is supported by a respective BBU.

In a first example, the role of the BBU (e.g. 3G or LTE) is selected and software files of the selected RAT is loaded at BBU card startup timing, depending on number of 3G/LTE cells required, number of installed BBU cards and each card slot position. The number of 3G/LTE cells may be provided by SDATA (System Data), which describes system configuration.

The operator or network element may define the number of cells for different radio access technologies (e.g. for 3G and LTE).

Alternatively, the number of cells for different radio access technologies may be defined at the base station depending on the interface between the REC (Radio Equipment Control) and the RE (Radio Equipment) used, the number of carriers of a RAT used on that interface, the number of cell presence, and the maximum cell number of a RAT that a BBU supports. In one example, the number of required 3G and LTE cells is determined using parameters which are given for every CPRI link. CPRI is an interface between the REC (Radio Equipment Control) and the RE, and the link between the REC and the RE (Radio Equipment) is known as a CPRI link. An alternative protocol is the OBSAI-PR3 protocol. Other interfaces may be used for this purpose. The RE and REC may correspond to the RRU and the BBU. The number of cells may be defined at a RAT Mode Assigner (RMA). The RMA may be a software module in the base station for software management. The RMA may belong to the BTS OAM (Operation Administration and Maintenance) component. The parameters per CPRI link may be described in a configured file. The cell counts are then determined as follows. The RMA may receive the following parameters, for example, from SDATA:
Prioritized RAT
Number of 3G CPRI Links: this parameter indicates whether 3G CPRI link is used, referred as N_{3GCpriUsed}
Number of 3G Carriers: this parameter indicates how many carriers are used on this CPRI, referred as N_{3GCarrierUsed}
Number of Cell presence: this parameter used as the cell setups, referred as N_{cellpresence}
Number of Max 3G Cell per BBU: this parameter used as the maximum 3G cell number that one BBU supports, referred as N_{Max3GcellSupportPerBBU}
Number of Max LTE Cell per BBU, this parameter used as the maximum LTE cell number that one BBU supports, referred as N_{MaxLTEcellSupportPerBBU}

The RMA may calculate Cell Count in dependence of these parameters:

N_{3GCell allocated}=N_{3GCpriUsed}* N_{3GCarrierUsed}

N_{LTECellallocated}=N_{CellPresence}

The RMA may determine the number of needed BBU cards for each RAT as follows:

The RMA may define the following variables and set initial values for the variables:
N_{LTEallocated}=0; number of BBU cards on which LTE service should be provided
N_{3Gallocated}=0; number of BBU cards on which 3G service should be provided
N_{remaining}=N_{BBUinstalled}; number of extra BBU cards which are not mandatory for LTE or 3G

The RMA may calculate the number of needed BBU cards for each RAT:

N_{3Gallocated}=mod(N_{3GCell allocated}, N_{Max3GcellSupportPerBBU})

N_{LTEallocated}=mod(N_{LTECell allocated}, N_{MaxLTEcellSupportPerBBU})

For example, the maximum number of 3G cells supported by one BBU and a maximum number of LTE cells supported by one BBU may be obtained when calculating number of BBUs for the 3G and LTE. Additionally or alternatively, some of the BBUs may be reserved for a specific RAT (e.g. in one example two BBUs are reserved for 3G so they are added to the number of cards allocated to 3G and subtracted from the number of remaining BBU cards)

Based on the cell count, provided either by the operator or determined in dependence of the CPRI parameters, the number of BBUs necessary for each RAT is determined. If there are remaining BBU cards, the RAT mode will be assigned for the remaining BBUs according by the “Prioritized RAT”. Table 1 shows an example of BBU mode allocation according to the prioritized RAT.

TABLE 1

| No | Priority | [Prioritized RAT] = 3G | [Prioritized RAT] = LTE |
|---|---|---|---|
| 1 | 1 (highest) | Set 3G mode to the needed BBU | Set LTE mode to the needed |
| | | cards. | BBU cards. |
| 2 | 2 | Set LTE mode to the needed BBU | Set 3G mode to the needed BBU |
| | | cards. | cards. |
| 3 | 3 | If there is remaining BBU card, set | If there is remaining BBU cards, |
| | | 3G mode to one BBU card in | set LTE mode to all BBU |
| | | order to use as the reserved | cards in order to use as the |
| | | card. | reserved cards. |
| 4 | 4 (lowest) | If there is remaining BBU cards, set | — |
| | | LTE mode to all BBU cards in | |
| | | order to use as the reserved | |
| | | cards. | |

Alternatively or additionally, BBU RAT requirements may be determined using the number of BBU cards required for specific RAT (e.g. WCDMA, LTE) in place of the number of cells for specific RAT (e.g. WCDMA, LTE). The number of BBUs required for each RAT mode may be defined by the operator or a network element. The number of BBUs reserved for a specific RAT may be defined by an operator or network element.

In one example, the RMA receives the following parameters, for example, from SDATA:
Prioritized RAT
Number of BBUs requested for LTE service, referred as N_{LTErequested}
Number of BBUs requested for 3G service, referred as N_{3Grequested}

In one example, in which two BBU cards are reserved for 3G, the RMA may define the following variables, which represent the number of required 3G BBU cards, excluding two BBU cards:

N_{3GrequestedWoSlot08}=Max(N_{3Grequested}−2, 0)

The RMA may define the following variables based on installed BBU cards and calculates correct values for the variables:

N_{BBUinstalled}: number of installed BBU cards

N_{BBUinstalledOnSlot08}: number of installed BBU cards on slots 0 and 8 (e.g. BBU0 and BBU8)

RMA may determine the “LRC Operation mode”, which shows whether LRC provides only LTE service or both 3G and LTE service:

If N_{3Grequested}=0, LRC Operation mode is “LTE single mode”

Otherwise LRC Operation mode is “Dual mode”

The “LRC Operation mode” may be multi-mode. That is, it may provide both 3G and LTE services at the same time.

The RMA may determine the number of needed BBU cards for each RAT by defining the following variables and setting initial values for the variables:
N_{LTEallocated}=0; number of BBU cards on which LTE service should be provided
N_{3Gallocated}=0; number of BBU cards on which 3G service should be provided
N_{remaining}=N_{BBUinstalled}; number of extra BBU cards which are not mandatory for LTE or 3G

The RMA may determine the number of needed BBU cards for each RAT by calculating the number of needed BBU cards for each RAT based on LRC operation mode:

If Operation mode is “LTE single mode” all installed BBU cards are reserved for LTE:
N_{LTEallocated} =N_{BBUinstalled}

If Operation mode is “Dual mode”:

The number of installed 3G specific BBU cards (e.g. BBU0 and BBU8) is reserved for 3G, i.e. they are added to the number of cards allocated to 3G and subtracted from the number of remaining BBU cards
N_{3Gallocated}+=N_{BBUinstalledOnSlot08}

The minimum number of required BBU cards are reserved for each RAT, e.g. they are added to the number of cards allocated for each RAT and subtracted from the number of remaining BBU cards. The cards are first reserved to the Prioritized RAT.
N_{3Gallocated}+=MIN{N_{3GrequestedWoSlot08}, N_{remaining}}
N_{LTEallocated}+=MIN{N_{LTErequested}, N_{remaining}}

The number of remaining BBU cards is reserved for each RAT depending on the Prioritized RAT. If Prioritized RAT is 3G and number of BBUs requested for 3G service (N_{3Grequested}) is bigger than or equal to two, one remaining BBU card is reserved for 3G and the rest are reserved for LTE

N_{3Gallocated}+=1

N_{LTEallocated}+=N_{remaining}

If Prioritized RAT is LTE, one spare BBU card is reserved to LTE, one spare BBU card is reserved for 3G if the number of BBUs requested for 3G service (N_{3Grequested}) is bigger than equal to two and the rest are reserved for LTE

N_{LTEallocated}+=1

N_{3Gallocate}d +=1

N_{LTEallocated}+=N_{remaining}

The RMA allocates each installed and reserved BBU card for either LTE or 3G. It is possible to reserve BBU cards for other RATs. By using the same method, assignation of RATs can be done for different RATs and/or different version of the RATs. The number of reserved BBU cards for a particular RAT, or version of a RAT, may be different from two, as in the example above, and may be zero. The method can be extended for assigning more than two different RAT modes.

In embodiments, the RAT priority parameter “Prioritized RAT” is set by the operator. In other embodiments the RAT priority may be set in the base station. “Prioritized RAT” is determined by the operation control strategy of the operator. The use of one RAT may be prioritized with regard to another because of load of the network, type of services used in the network, time, charging, events in the coverage area, energy consumption and/or load of the HW resources. Either RAT may be prioritized. In some cases, 3G and LTE resource will not be evenly distributed, so this parameter is raised in this background.

The RAT mode of the BBUs may be assigned based on the priority of the RAT and the required BBUs for each. For a multimode base station, when dual mode is used (e.g. supporting both LTE and 3G at the same time) the parameter “prioritized RAT” is used to indication how to allocate the reserved BBU resource. In one example, “remaining BBU cards” may be taken into use if there is need for further cells (e.g. depending on the load) and the type of RAT for the BBU may be determined based on the priority parameter.

In one example, if further BBU cards are added to the base station, the type of RAT can be determined based on the priority parameter.

In step 2 of the method of FIG. 5, the BBUs are then caused to operate in the determined radio access technology. Software files of the selected RAT may be loaded at BBU startup timing, depending on one or more of: number of 3G/LTE cells required by configured file; number of required 3G/LTE BBUs; number of installed BBU cards; and each card slot position.

Thus, in one embodiment, according to cell number, RAT Priority and the available hardware, the BBU is assigned an appropriate RAT mode. The RAT mode can be adjusted dynamically when cell number, RAT priority or available hardware changes. These operations involve only a reset of the specific BBU device, rather than the base station.

If the RAT mode corresponding to a BBU of the multi-mode base station is flexible, LRC can obtain the right software by the selected RAT mode rather than by a first logic type, speeding up the start up process of the base station.

When subscriber capacity increases necessitates network capacity expansion, secondary network planning may be simplified, cutting the cost of network capacity expansion. In a cloud base station with BBUs pool, network capacity expansion may become more efficient for the operator.

FIG. 6 shows a method of operation of a management entity. In a first step, T1, the management entity receives parameters such as number of 3G/LTE cells, number of 3G/LTE BBUs and/or Prioritized RAT. The management entity may receive the parameters from an operator or from a configured file.

In a second step T2, the management entity signals the parameters to the base station, e.g. via CPRI or OBSAI-PR3 protocol, or another interface.

The method may be implemented on a control apparatus as shown in FIG. 5. FIG. 5 shows an example of a control apparatus for a communication system, for example to be coupled to and/or for controlling a station of an access system, such as a base station. In some embodiments, base stations comprise a separate control apparatus. In other embodiments, the control apparatus can be another network element such as a radio network controller. The control apparatus can be an apparatus via which the operator can manage the network configurations, e.g. NetAct OSS. In some embodiments, each base station may have such a control apparatus as well as a control apparatus being provided in a radio network controller. The control apparatus 109 can be arranged to provide control on communications in the service area of the system. The control apparatus 109 comprises at least one memory 301, at least one data processing unit 302, 303 and an input/output interface 304. Via the interface the control apparatus can be coupled to a receiver and a transmitter of the base station. For example the control apparatus 109 can be configured to execute an appropriate software code to provide the control functions.

It is noted that whilst embodiments have been described in relation to LTE and 3G, similar principles can be applied to any other communication system where a multi-mode radio access is supported. For example, the method can be adapted to assign more than two RAT modes. One or more of LTE or 3G may be replaced by one or more other technologies. The other technologies may be different versions of the same technology. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), FPGA, gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

Indeed in there is a further embodiment comprising a combination of one or more embodiments with any of the other embodiments previously discussed.

1. A method comprising:
determining for a plurality of baseband units, in dependence on one or more parameters, which radio access technology is supported by a respective base band unit; and
causing said baseband unit to operate in said respective radio access technology.

2. A method according to claim 1, wherein the one or more parameters comprises the number of cells supported by the respective radio access technology.

3. A method according to claim 1, wherein the one or more parameters comprises the number of the plurality of baseband units required to support the respective radio access technology.

4. A method according to claim 1, wherein the parameters are related to the base station interface protocol.

5. A method according to claim 1, comprising obtaining software configured to run the baseband unit according to the determined radio access technology mode.

6. A method according to claim 1, wherein the one or more parameters comprises radio access technology prioritisation information.

7. A method according to claim 6, comprising using the radio access technology prioritisation information to determine which of said plurality of baseband units is first caused to operate in said respective radio technology.

8. A method according to claim 6, comprising using the radio access technology prioritisation information to determine which radio access technology is supported by a respective base band unit, for at least one baseband unit that is not required to support a particular radio access technology.

9. A method according to claim 1, comprising receiving the parameters from a network management node.

10. A method according to claim 1, wherein the base band unit is capable of supporting a plurality of different radio access technologies or versions of radio access technologies.

11. A method according to claim 1, wherein the radio access technology is one of a version of 3G and a version of LTE.

12. A method comprising:
receiving parameters at a network management node for use in determining, for a plurality of baseband units, which radio access technology is supported by a respective base band unit; and
causing the parameters to be sent to a base station arrangement.

13. A method according to claim 12, wherein the one or more parameters comprises at least one of the number of cells supported by the respective radio access technology, the number of the plurality of baseband units required to support the respective radio access technology, and radio access technology prioritisation information.

14. A method according to claim 12, wherein the radio access technology is one of a version of 3G and a version of LTE.

15. An apparatus, said apparatus comprising at least one processor and at least one memory including computer code for one or more programs, the at least one memory and the computer code configured, with the at least one processor, to cause the apparatus at least to determine for a plurality of baseband units, in dependence on one or more parameters, which radio access technology is supported by a respective base band unit; and
cause said respective base band unit to operate in said respective radio access technology.

16. An apparatus according to claim 15, wherein the one or more parameters comprises the number of cells supported by the respective radio access technology.

17. An apparatus according to claim 15, wherein the one or more parameters comprises the number of the plurality of baseband units required to support the respective radio access technology.

18. An apparatus according to claim 15, wherein the parameters are related to the base station interface protocol.

19. An apparatus according to claim 15, wherein the at least one memory and computer code are configured to cause the apparatus to obtain software configured to run the baseband unit according to the determined radio access technology mode.

20. An apparatus according to claim 15, wherein the one or more parameters comprises radio access technology prioritisation information.

21. An apparatus according to claim 20, wherein the at least one memory and computer code are configured to cause the apparatus to use the radio access technology prioritisation information to determine which of said plurality of baseband units is first caused to operate in said respective radio technology.

22. An apparatus according to claim 20, wherein the at least one memory and computer code are configured to cause the apparatus to use the radio access technology prioritisation information to determine which radio access technology is supported by a respective base band unit, for at least one baseband unit that is not required to support a particular radio access technology.

23. An apparatus according to claim 15, comprising receiving the parameters from a network management node.

24. An apparatus according to claim 15, wherein the base band unit is capable of supporting a plurality of different radio access technologies or versions of radio access technologies.

25. An apparatus according to claim 15, wherein the radio access technology is one of a version of 3G and a version of LTE.

26. An apparatus, said apparatus comprising at least one processor and at least one memory including computer code for one or more programs, the at least one memory and the computer code configured, with the at least one processor, to cause the apparatus at least to
receive parameters at a network management node for use in determining, for a plurality of baseband units, which radio access technology is supported by a respective base band unit; and
cause the parameters to be sent to a base station arrangement.

27. An apparatus according to claim 26, wherein the one or more parameters comprises at least one of the number of cells supported by the respective radio access technology, the number of the plurality of baseband units required to support the respective radio access technology, and radio access technology prioritisation information.

28. An apparatus according to claim 26, wherein the radio access technology is one of a version of 3G and a version of LTE.

29. A base station arrangement comprising:
a plurality of baseband units, each baseband unit capable of supporting a plurality of different radio access technologies or different versions of a radio access technology; and
a controller configured to determine which radio access technology is supported by one or more of said baseband units in dependence of one or more parameters and cause said baseband unit to operate in said respective radio access technology.

30. A computer program comprising computer executable instructions which when run are configured to perform the method of claim 1.
